(19) United States
(12) Patent Application Publication
(10) Pub. No.: US 2011/0224998 A1
(43) Pub. Date: Sep. 15, 2011

(54) Online Care For Provider Practices

(76) Inventor: Roy Schoenberg, Boston, MA (US)

(21) Appl. No.: 13/045,380

(22) Filed: Mar. 10, 2011

Related U.S. Application Data
(60) Provisional application No. 61/312,547, filed on Mar. 10, 2010.

(51) Int. Cl. G06Q 10/00

(52) U.S. Cl. 705/1.1

(57) ABSTRACT

A computer-implemented method includes sending by one or more computers in response to a request a status indicator associated with a service provider that has a virtual waiting room generated by a computer system; receiving by the one or more computers a request to enter the virtual waiting room; accessing by the one or more computer systems an appointment schedule that indicates the service provider's appointments in a physically located office of the service provider; analyzing by the one or more computers the request and the appointment schedule; and causing the one or more computers to admit or deny entry to the virtual waiting room based at least in part on the analysis of the appointment schedule associated with the service provider and the status indicator.

### CLAIM OF PRIORITY

This application claims priority under 35 U.S.C. §119(e) to provisional U.S. Patent Application 61/312,547, filed on Mar. 10, 2010, the entire contents of which are hereby incorporated by reference.

### BACKGROUND

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In one aspect of the present disclosure, a computer-implemented method includes sending by one or more computers in response to a request a status indicator associated with a service provider that has a virtual waiting room generated by a computer system; receiving by the one or more computers a request to enter the virtual waiting room; accessing by the one or more computer systems an appointment schedule that indicates the service provider's appointments in a physically located office of the service provider; analyzing by the one or more computers the request and the appointment schedule; and causing the one or more computers to admit or deny entry to the virtual waiting room based at least in part on the analysis of the appointment schedule associated with the service provider and the status indicator.

Implementations of the disclosure may include one or more of the following features. In some implementations, the method further includes sending to one or more consumer computers an pre-intake questionnaire. The method may also include generating a graphical user interface that when rendered on a display device renders a visual representation of the virtual waiting room, the visual representation comprising a visual indicator of a number of patients in the virtual waiting room and a visual indicator of an amount of time a patient has been waiting in the virtual waiting room.

In other implementations, the method includes generating a graphical user interface that when rendered on a display device renders a visual representation of the virtual waiting room, the visual representation comprising a visual indicator of a number of patients in the virtual waiting room and a number of patients in the service provider's physical waiting room, and a visual indicator of an amount of time a patient has been waiting in the virtual waiting room. The method additionally includes generating a graphical user interface that when rendered on a display device renders a visual representation of a storefront that displays visual indicators of service providers associated with a medical practice.

In still other implementations, the method includes determining that a requested service provider is not logged into the brokerage system; identifying a service provider that is available to cover for the requested service provider; and establishing a communication channel between the covering service provider and a consumer requesting a consultation. The method may also include determining by the one or more computer systems that the waiting room had reached a threshold capacity limit; and closing by the one or more computer systems the waiting room to the admittance of new patients when the determined capacity has reached the threshold capacity.

In another aspect of the disclosure, one or more machine-readable media are configured to store instructions that are executable by one or more processing devices to perform operations including sending by one or more computers in response to a request a status indicator associated with a service provider that has a virtual waiting room generated by a computer system; receiving by the one or more computers a request to enter the virtual waiting room; accessing by the one or more computer systems an appointment schedule that indicates the service provider's appointments in a physically located office of the service provider; analyzing by the one or more computers the request and the appointment schedule; and causing the one or more computers to admit or deny entry to the virtual waiting room based at least in part on the analysis of the appointment schedule associated with the service provider and the status indicator. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: sending by one or more computers in response to a request a status indicator associated with a service provider that has a virtual waiting room generated by a computer system; receiving by the one or more computers a request to enter the virtual waiting room; accessing by the one or more computer systems an appointment schedule that indicates the service provider's appointments in a physically located office of the service provider; analyzing by the one or more computers the request and the appointment schedule; and causing the one or more computers to admit or deny entry to the virtual waiting room based at least in part on the analysis of the appointment schedule associated with the service provider and the status indicator. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### DESCRIPTION OF DRAWINGS

FIG. 1 is a diagrammatic view of an engagement brokerage service.

FIGS. 2A-B are screenshots of graphical user interfaces that when rendered on a display device renders a visual representation of a waiting room.

FIG. 3 is a flow chart of a process for facilitating patient care with the Online Care Practice.

FIG. 4 is a flow chart of a process of performing various actions using a graphical user interface.

FIG. 5 is a block diagram of a computer (computer system) showing exemplary components that can be used for the brokerage system and/or client systems.

### DETAILED DESCRIPTION

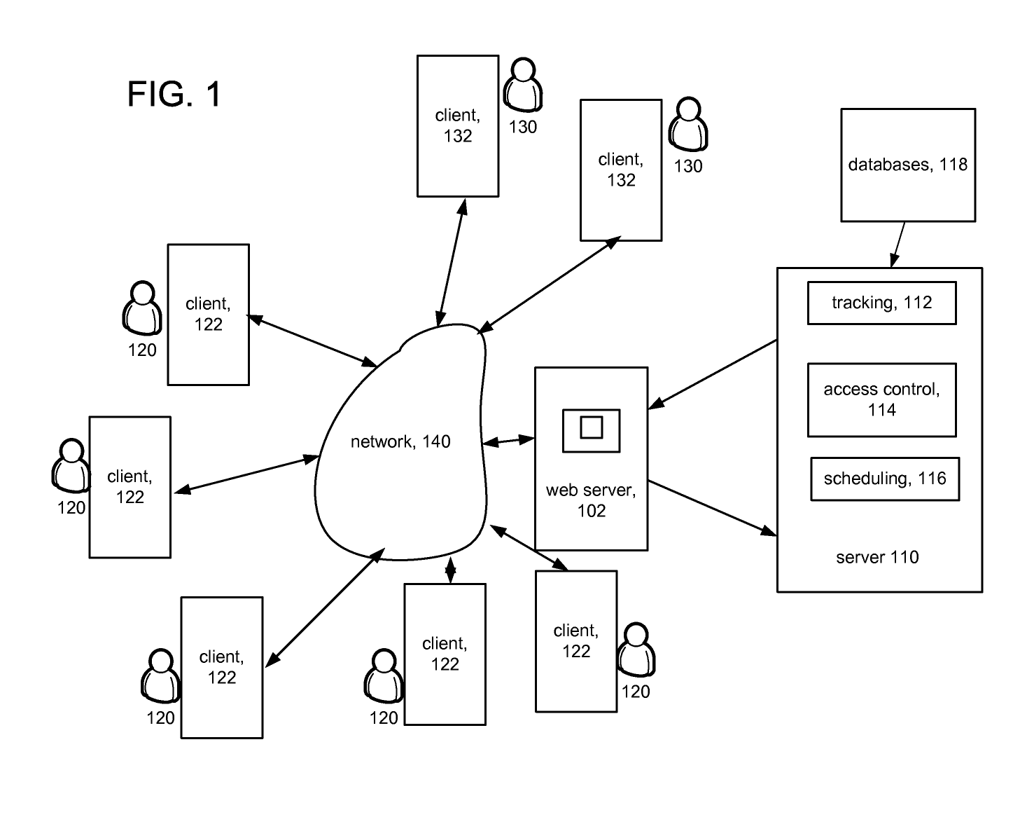

FIG. 1 shows an example system 100 implementing the brokerage service. The system 100 includes a computerized system or server 110 for making connections between consumers 120, at client systems 122, including mobile devices and PDAs, and service providers 130, at client systems 132, over a network 140, e.g., the Internet or other types of networks. The computerized system 110 operates as a service running on a web server 102.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider may be contacted. In some examples of an active system, the provider's mobile device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number of the provider's mobile device with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations, as is commonly known in the art.

Using the system 100, a consumer 120 communicates with a provider 130. The consumers 120 and providers 130 connect to the computerized system 110 through a graphical user interface displayed on a mobile device and served by the web server 102 using client devices 122 and 132, respectively. Client devices 122 and 132 include any combination of mobile devices, PDAs, cellular phones, computer systems, and so forth. The client devices 122 and 132 enable the consumers 120 to input and receive information as well as to communicate via video, audio, and/or text with the providers 130.

Online Care Practice

A portion of the brokerage system 100 includes components for the management of a physician's medical practice. Collectively, these components are referred to herein as “Online Care Practice, system.” Using the Online Care Practice system, a physician's office registers patients, presents patients with forms/questionnaires to be completed prior to a consultation, triages a patient, places a patient in a waiting room, clears a patient to be seen by a physician, and so forth.

Through Online Care Practice system, providers of services integrate interactions with the brokerage system 100 with their physical practice (e.g., patients seen in a physical office), allowing service providers the flexibility to seamlessly manage their virtual practice while caring for patients in their physical practice. Providers integrate their physical practices with the brokerage system 100 into the providers' respectively, existing office hours. Through Online Care Practice system, providers leverage their existing administrative support staff and designate other providers in the practice to provide coverage to patients seeking care, when a particular provider is unavailable. In an example, the Online Care Practice system receives information from a physician's physical office. In this example, the Online Care Practice system may receive information from a physician's physical office when support staff associated with the physical office manually enter information into the Online Care Practice system, for example through a graphical user interface through which the Online Care Practice system received information related to a physical office. In another example, a physician's physical office includes a data tracking system that is configured to track data internal to the physician's physical office, including, e.g., a number of patient's that have registered with the physician's office, a number of patients that are currently waiting in a physician's waiting room, physician notes, physicians' schedules and appointments, and so forth. The tracking system is configured to send the data related to the physician's physical office to the brokerage system for integration with the brokerage system.

### Access Type

The various components of Online Care Practice system are restricted such that only certain users of the brokerage system have access to certain components of Online Care Practice. User access type specifies which components a particular type of user has permission to access. One access type is practice manager access. A user with practice manager access is able to configure the Online Care Practice system, for example, by granting other users practice manager access, specifying physicians that are associated with the Online Care Practice system, and granting users other access types, including, e.g., support staff access, as described in further detail below.

The support staff access type allows users to perform certain pre-defined tasks, including, e.g., managing the storefront, scheduling appointments, registering patients, triaging patients, and so forth, each of which is described in further detail below.

### Storefront

A component of the Online Care Practice system includes a virtual storefront, in which a physician's practice lists names of physicians and other practitioners associated with the practice, hours of operation, and other relevant information (e.g., the logo, other images, and the welcome message). Through the storefront, patients schedule appointments to consult with a physician and/or request a consultation with those physicians or other practitioners associated with the practice.

The virtual storefront also includes an indicator of the availability of the physicians, including, e.g., whether particular physicians are available for a consultation or are engaged with another patient or offline and so forth. The storefront also includes links, selection of which causes a request to be sent to the brokerage system 100 to establish a communication channel between the patient and a selected physician.

### Appointment Scheduler

Another component of the Online Care Practice system includes an appointment scheduler, through which users manage appointments for physicians, including, e.g., by cancelling appointments from a physician's calendar, by adding appointments to the physician's calendar, and so forth.

### Cover Manager

Another component of the Online Care Practice system includes a cover manager that is configured to determine whether a physician is logged into the brokerage system to consult with patients. The cover manager maintains a list of “back-up physicians,” e.g., physicians that are available to cover or to provide consultation services for another service provider that is not logged into the brokerage system.

In an example, the cover manager maintains a matrix that includes information specifying times for which a particular physician is available for consultations and times for which the particular physician is unavailable for consultations. For the times that the particular physician is unavailable, the matrix includes a list of other physicians (e.g., “covering physicians”) that are available to provide services in place of the particular physician. The covering physicians are tiered based on skill level and/or times that the covering physicians are available.

In an example, a physician requires covering physicians from the hours of 11 AM-2 PM. In this example, one covering physician is available from 11 AM-12 PM and another covering physician is available from 12 PM-2 PM. The two covering physicians are tiered based on the time slots in which they are available, with the physician that is available from 11 AM-12 PM being placed in a first tier above the other physician that is available from 12 PM-2 PM.

In another example, the physicians are tiered based on skill level. In this example, one covering physician is an expert in a medical field. Another covering physician is a medical resident that is being trained. The two covering physicians are tiered such that the covering physician who is the expert is contacted first to cover for another physician. If this expert physician is unavailable or otherwise unresponsive to pages, the medical resident is contacted to cover for the other physician.

### Waiting Room

Another component of the Online Care Practice system is a virtual waiting room, in which patients are placed in a queue to wait for a physician that is engaged with another patient. The waiting room is associated with a graphical user interface that when rendered on a display device renders a visual representation of an availability status of a provider, a number of patients waiting for the provider, a number of appointments for a provider, a number of walk-ins for the provider, a number of patients that have been cleared from the provider's queue, and so forth.

For each patient that is placed in the waiting room, the waiting room is associated with another graphical user interface that displays information pertaining to the patient, including, e.g., the patient's name, the patient's status, whether the patient has a previous relationship with this provider or not, how long the patient has been waiting, and so forth.

Another graphical user interface associated with the waiting room provides a service provider with additional patient information, including, e.g., a patient summary, which includes topics to discuss, responses to triage questions, and the patient's health summary, an interface through which a user engages in a text chat with the patient to solicit additional information and to prepare the patient for an upcoming visit with the provider, an interface through which the user takes notes about the patient that may be helpful for the provider to review prior to engaging in a conversation with the patient, an interface through which the user may remove the patient from the waiting room, and so forth.

If the provider's ability to see patients, changes, or the provider becomes too busy in the regular practice, the waiting room includes a control device through which users control the volume of patients entering the waiting room by opening/closing the waiting room doors to patients with whom the provider does not have a previous relationship.

The virtual waiting room generated by a computer system is closed by the computer system to admittance of new patients based on the computer system determining that the number of existing physician appointments exceeds some preset value. The value can be the number of patients that the physician will see over the course of the day or over an interval of time.

In an example, the physician's schedule is fully booked except for one opening in the physician's schedule. A walk-in patient that is waiting for the single, open appointment is placed in the waiting room. At this point, the physician's schedule is fully booked and the physician cannot see any additional patients. Accordingly, the computer system closes the physician's waiting room to the admittance of new patients. Additionally, the physician's waiting room may also be closed based on the physician's availability status. For example, if the physician has an availability status of “busy” or otherwise unavailable, the computer system closes the physician's waiting room.

Additionally, users have the ability to change the provider's availability status to limit patients without a scheduled appointment from entering the waiting room. If covering providers have been enabled, patients are shown a link to view a list of “covering” providers, to ensure the patient has access to care. Users can change a provider to an unavailable status if the provider wishes to prevent new users from entering the waiting room, or is no longer able to see patients.

The computer system generating the waiting room also generates another graphical user interface that renders a visual representation of upcoming physician appointment appointments, a visual representation of the name, status, and wait time of patients in the waiting room, a visual representation of whether a physician has a previous relationship with a patient, a visual representation of a patient summary, which includes topics to discuss, responses to triage questions, a health summary, and notes entered by a user of the brokerage system 100.

A provider selects a patient from the waiting room to begin a conversation. During the conversation, providers have the option to recommend a post visit follow-up for the patient, and send follow-up instructions to users.

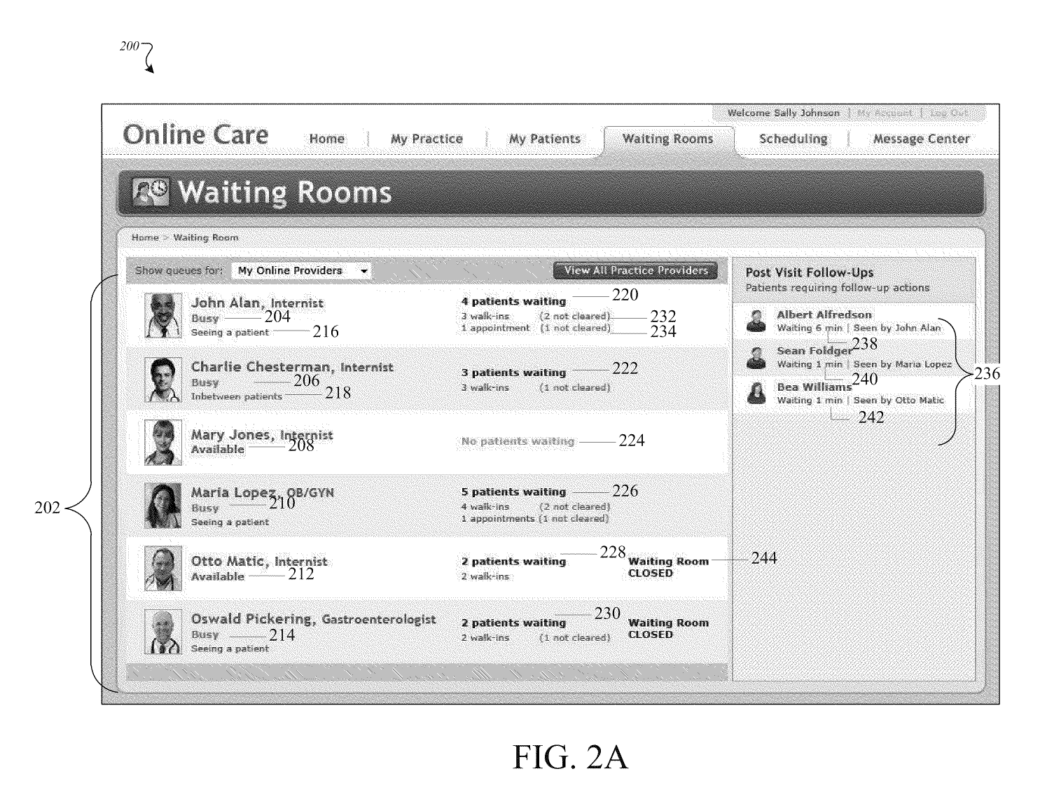

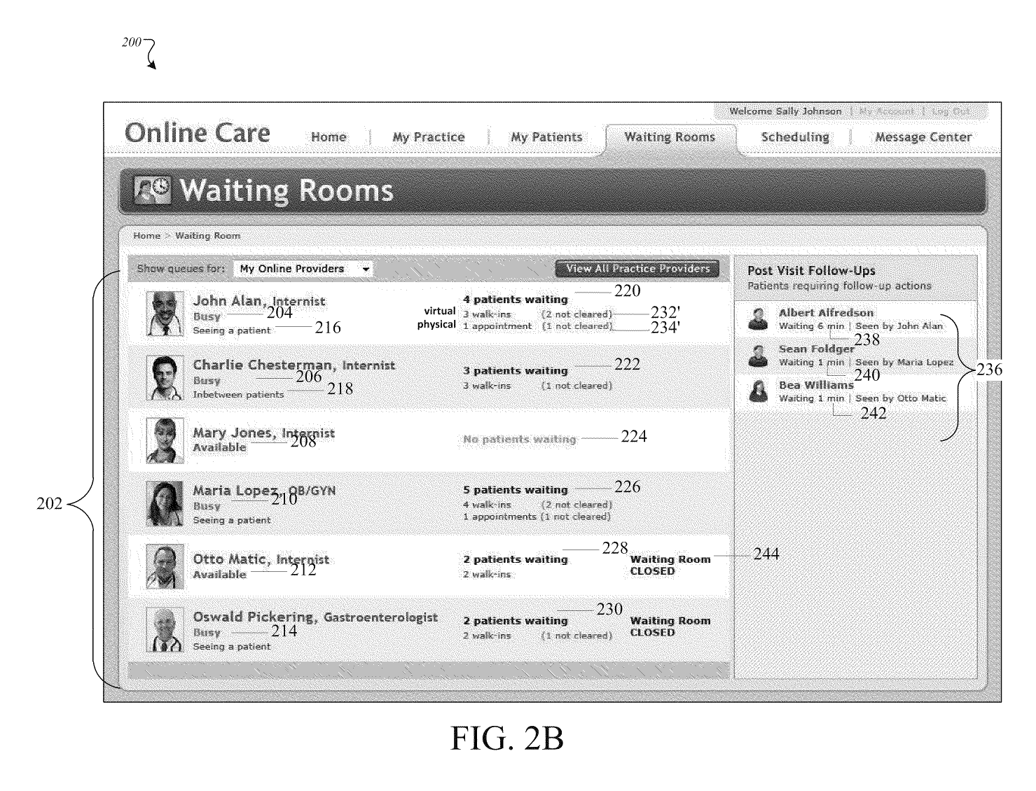

FIG. 2A is a screenshot of graphical user interface 200 that when rendered on a display device renders a visual representation of a virtual waiting room. Section 202 of graphical user interface 200 displays a list of service providers that are associated with the virtual waiting room.

Graphical user interface 200 includes status indicators 204, 206, 208, 210, 212, 214 that display information indicative of a physician's availability status, including, e.g., busy, available, and so forth. Additionally, for physician's that are busy, graphical user interface 200 displays visual indicators 216, 218 that display information indicative of why a physician is busy, including, e.g., the physician is seeing a patient, the physician is in between patients, and so forth. Graphical user interface 200 also includes visual indicators 220, 222, 224, 226, 228, 230, which display information specifying whether a physician has patients waiting in the physician's waiting room and if so the number of patients waiting.

In the example of FIG. 2A, graphical user interface 200 also includes visual indicators 232, 234, which display information specifying a number of patients waiting in the waiting room that have scheduled appointments and a number of patient waiting in the waiting room that are walk-ins. Graphical user interface 200 displays visual indicators specifying a number of patients that have been cleared through the check-in process. The check-in process includes receiving patient's questions to the in-take forms and having a member of the support staff; perform a preliminary evaluation on the patient, as described herein. Following completion of the check-in process, the patient is “cleared” to be seen by a physician. Graphical user interface 200 also includes visual indicator 244, which displays information indicating that a waiting room for a physician has been closed.

Section 236 of graphical user interface 200 displays a listing of patients requiring follow-up actions. Visual indicators 238, 240, 242 display information specifying an amount of time a patient requiring a follow-up action has been waiting.

In the example of FIG. 2A, visual indicator 232 does not specify whether the patients that are waiting in the waiting room and are walk-ins are walk-ins to the physician's physical office or are virtual walk-ins that have requested an online consultation with a physician. Similarly, visual indicator 234 does not specify whether the patients that are waiting in the waiting room and have appointments have appointments with the physician in a physical office or have online appointments to engage with a physician. Accordingly, visual indicators 232, 234 are cumulative indicators in that indicators 232, 234 do not differentiate between patients that are interacting with a physician's physical office and patients that are interesting with a physician's virtual office, e.g., through the Online Care Practice system. FIG. 2B includes a variation of FIG. 2A, in which graphical user interface 200 breaks down the types of patients waiting in a waiting room to physical patients (e.g., patients that have appointments with a physician in the physician's physical office and/or patients that are waiting in a physician's physical waiting room) and virtual patients (e.g., patients that have online appointments with a physician and/or patients that are waiting in a physician's virtual waiting room). In the example of FIG. 2B, visual indicator 232′ specifies a number of virtual patients that are walk-ins (e.g., having requested online consultations without appointments). Visual indicator 234′ specifies a number of patients that have physical appointments with a physician, for example, in the physician's physical office. Any combination of visual indicators specifying cumulative indicators, virtual indicators, and/or physical indicators may be used in the graphical user interfaces generated by the Online Care Practice System.

### Post Visit Follow-Ups

In the waiting room graphical user interface of FIGS. 2A-2B, users view a list of patients who have been recommended for follow-up care. Users select a patient from the list to begin the follow-up conversation. From a follow-up graphical user interface, users chat with the patient to provide additional information based on instructions sent by the provider. Additionally, users schedule a follow-up appointment for the patient, generate a referral form, or a sick slip for the patient's employer.

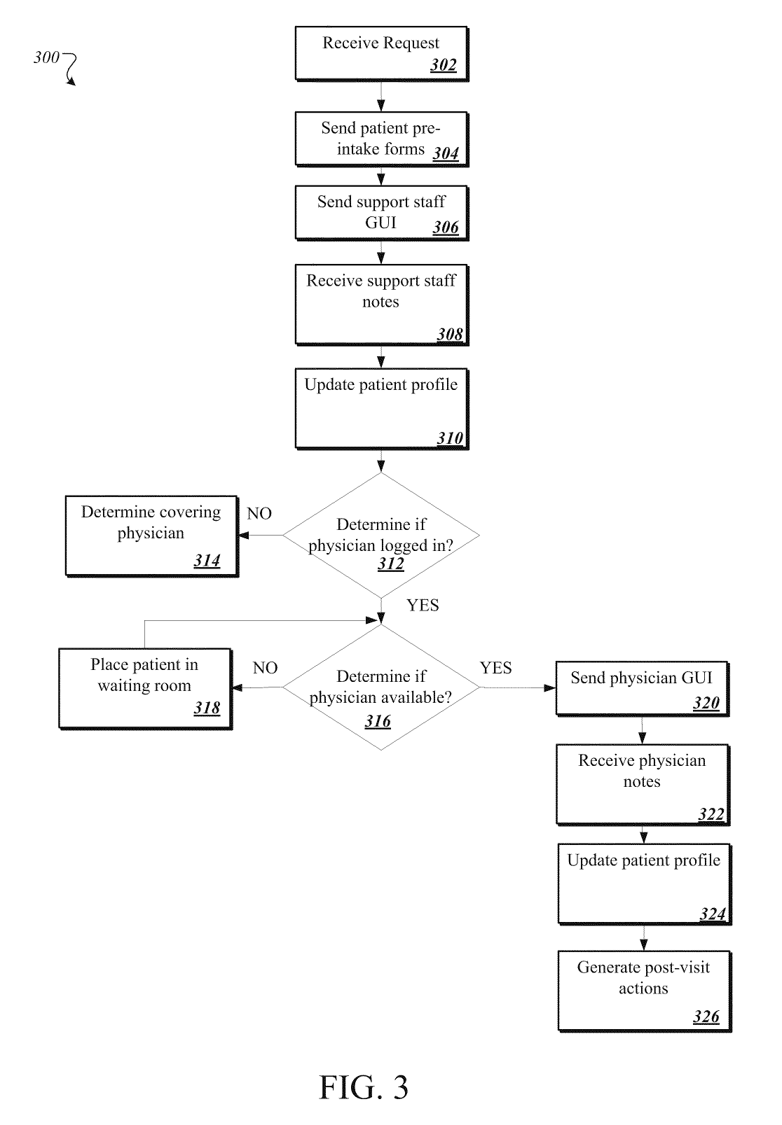

FIG. 3 is a flow chart of process 300 for facilitating patient care with the Online Care Practice. In operation system 100 receives (302) a request from a consumer for a consultation with a physician. System 100 sends (304) pre-intake forms, including, e.g., questionnaires, to a computing device associated with the patient. The patient completes the pre-intake forms and sends the pre-intake forms back to server 100. System 100 also sends (306) a support staff graphical user interface to computing devices associated with a practice. The support staff graphical user interface includes questions for support staff (e.g., nurses, administrative assistants, and so forth) to fill out prior to the patient's consultation with the physician.

In response to sending the support staff graphical user interface, system 100 receives (308) support staff notes, including, e.g., answers to questions included in the support staff graphical user interface. Using the received support staff notes and the patient's answers to the questionnaires, system 100 updates (310) a patient's profile. System 100 also determines (312) whether the requested physician is logged into the brokerage system, for example, to consult with patients. If the requested physician is not logged into the brokerage system, system 100 determines (314) a covering physician (e.g., a physician that is covering for the requested physician). The brokerage system establishes (not shown) a communication channel between the covering physician and the patient.

If system 100 determines that the physician is logged into the brokerage system, system 100 determines (316) whether the physician is currently available for a consultation with the patient. If the physician is not currently available, system 100 places (318) the patient in the waiting room. If the physician is currently available, system 100 sends (320) a physician graphical user interface to a computing device associated with the physician. The physician graphical user interface includes text fields and boxes into which the physician can enter notes and assessments regarding the patient.

In response to sending the physician graphical user interface, system 100 receives (322) physician notes regarding the patient. System 100 updates (324) the patient's profile using the physician notes. Additionally, using the physician notes, system 100 generates (326) post visit follow-up actions.

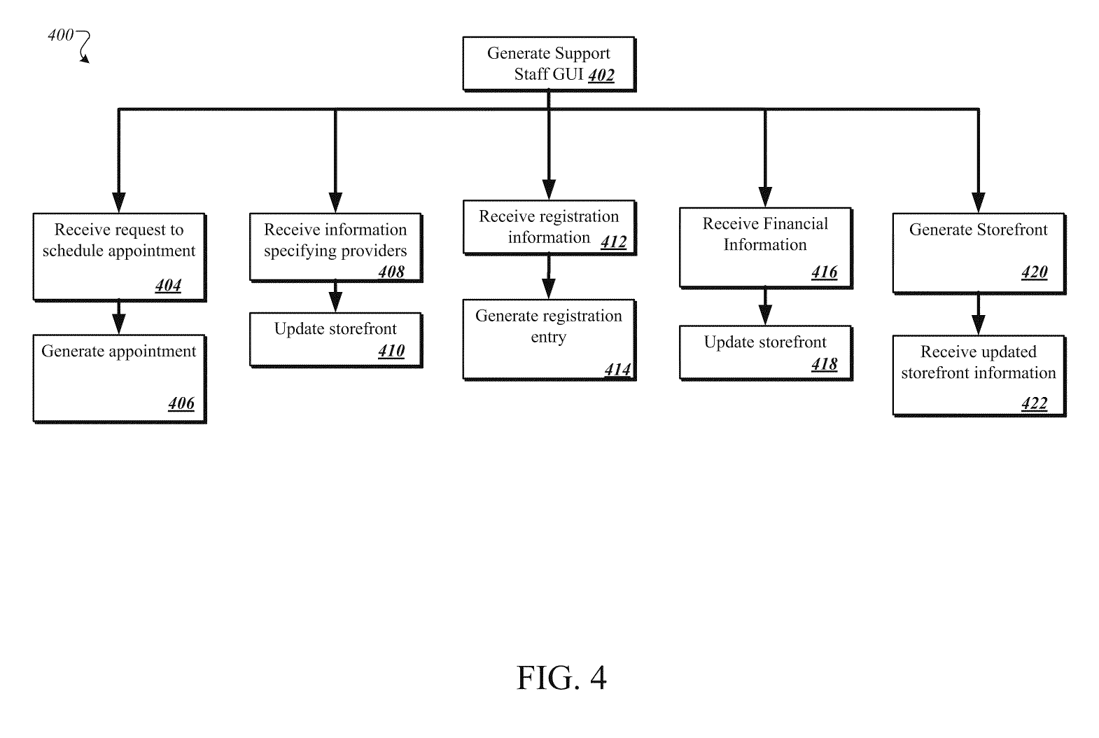

FIG. 4 is a flow chart of process 400 of performing various actions using the support staff graphical user interface. As previously described, the support staff of a practice use Online Care Practice system to establish a virtual presence, including, e.g., a virtual storefront, and to attend to administrative matters regarding the practice, including, e.g., registering patients, reviewing financial information, and so forth.

In operation, system 100 generates (402) support staff graphical user interface. System 100 sends (not shown) support staff graphical user interface to computing devices associated with the practice. Through the support staff graphical user interface, system 100 receives (404) a request to schedule an appointment with a physician. Following receipt of the request, system 100 generates (406) an appointment with the physician.

Additionally, the support staff graphical user interface is also used by the support staff to update a storefront for a practice. Through the support staff graphical user interface, system 100 receives (408) information specifying the physicians that are associated with a practice. System 100 updates (410) the storefront with the information specifying the physicians that are associated with the practice.

The support staff graphical user interface is also used to register patients with a practice. Through the support staff graphical user interface, system 100 receives (412) patient registration information. Using the received patient registration information, system 100 registers the patient with the practice, e.g., by generating (414) a registration entry in the data repository. The registration entry includes information specifying the name of the patient, medical status and notes for the patient, whether the patient has a pre-existing relationship with a physician, and so forth.

The support staff graphical user interface is also used to manage financial information for a practice and the financial information is made accessible through the storefront. Through the support staff graphical user interface, system 100 receives (416) financial information, including, e.g., information indicative of revenues for the practice, information indicative of co-payments collected, and so forth. Using the received financial information, system 100 updates (418) the storefront with the received financial information. The financial information is accessible through the storefront to users associated with a predefined access type, including, e.g., a practice manager access type.

Additionally, through the support staff graphical user interface, system 100 receives a request to generate a storefront, generates (420) the storefront, receives (422) from a member of the support staff storefront information, and updates the storefront with the received information.

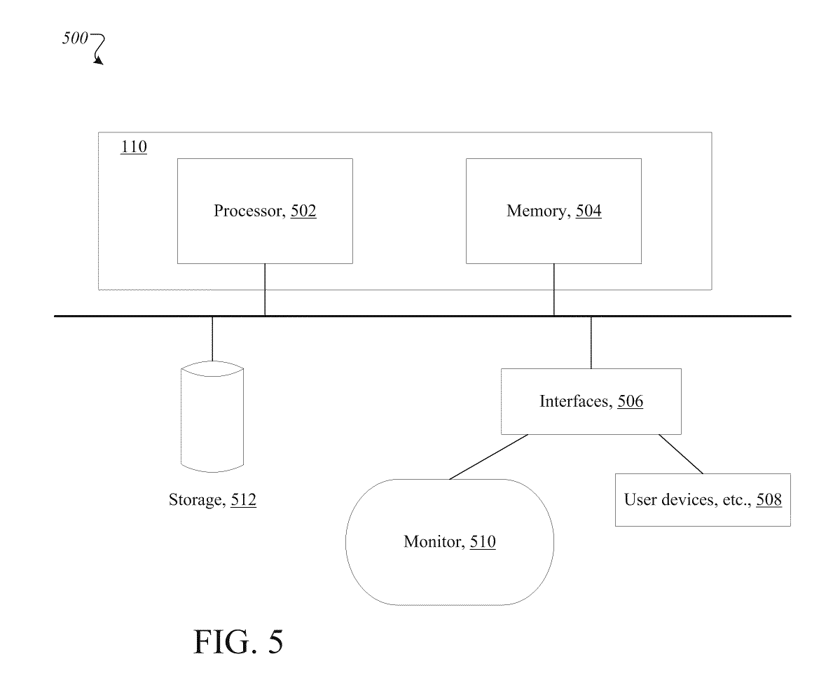

FIG. 5 is a block diagram of components 500 of the engagement brokerage system. User devices 508 can be any sort of computing device capable of taking input from a user and communicating over a network (not shown) with server 110 and/or with other client devices. For example, user device 508 can be a mobile device, a desktop computer, a laptop, a cell phone, a personal digital assistant (“PDA”), a server, an embedded computing system, a mobile device and so forth. User devices 508 include monitor 510 which render visual representations of interface 506.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device user device 508 via interfaces 506, including, e.g., graphical user interfaces. Interfaces 506 can be any type of interface capable of receiving information over a network, such as an Ethernet interface, a wireless networking interface, a fiber-optic networking interface, a modem, and so forth. Server 110 also includes a processor 502 and memory 504. A bus system (not shown), including, for example, a data bus and a motherboard, can be used to establish and to control data communication between the components of server 110.

Processor 502 may include one or more microprocessors. Generally, processor 502 may include any appropriate processor and/or logic that is capable of receiving and storing data, and of communicating over a network (not shown). Memory 504 can include a hard drive and a random access memory storage device, such as a dynamic random access memory, machine-readable media, or other types of non-transitory machine-readable storage devices.

Components 500 also include storage device 512, which is configured to store information collected through the brokerage system during a service provider's consultation with a consumer. In another example, storage device 512 is also configured to receive information (e.g., a number of patient's waiting in a physical waiting room) from a physician's physical office and to integrate and to integrate the information associated with the physical office into the brokerage system so that the brokerage system may access and may use the information associated with the physical office space.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
sending by one or more computers in response to a request a status indicator associated with a service provider that has a virtual waiting room generated by a computer system;
receiving by the one or more computers a request to enter the virtual waiting room;
accessing by the one or more computer systems an appointment schedule that indicates the service provider's appointments in a physically located office of the service to provider;
analyzing by the one or more computers the request and the appointment schedule; and
causing the one or more computers to admit or deny entry to the virtual waiting room based at least in part on the analysis of the appointment schedule associated with the service provider and the status indicator.

2. The computer-implemented method of claim 1 further comprising:
sending to one or more consumer computers an pre-intake questionnaire.

3. The computer-implemented method of claim 1, further comprising:
generating a graphical user interface that when rendered on a display device renders a visual representation of the virtual waiting room, the visual representation comprising a visual indicator of a number of patients in the virtual waiting room and a visual indicator of an amount of time a patient has been waiting in the virtual waiting room.

4. The computer-implemented method of claim 1, further comprising:
generating a graphical user interface that when rendered on a display device renders a visual representation of the virtual waiting room, the visual representation comprising a visual indicator of a number of patients in the virtual waiting room and a number of patients in the service provider's physical waiting room, and a visual indicator of an amount of time a patient has been waiting in the virtual waiting room.

5. The computer-implemented method of claim 1, further comprising:
generating a graphical user interface that when rendered on a display device renders a visual representation of a storefront that displays visual indicators of service providers associated with a medical practice.

6. The computer-implemented method of claim 1, further comprising:
determining that a requested service provider is not logged into the brokerage system;
identifying a service provider that is available to cover for the requested service provider; and
establishing a communication channel between the covering service provider and a consumer requesting a consultation.

7. The computer-implemented method of claim 1, further comprising:
determining by the one or more computer systems that the waiting room had reached a threshold capacity limit; and
closing by the one or more computer systems the waiting room to the admittance of new patients when the determined capacity has reached the threshold capacity.

8. One or more machine-readable media configured to store instructions that are executable by one or more processing devices to perform operations comprising:
sending by one or more computers in response to a request a status indicator associated with a service provider that has a virtual waiting room generated by a computer system;
receiving by the one or more computers a request to enter the virtual waiting room;
accessing by the one or more computer systems an appointment schedule that indicates the service provider's appointments in a physically located office of the service provider;
analyzing by the one or more computers the request and the appointment schedule; and
causing the one or more computers to admit or deny entry to the virtual waiting room based at least in part on the analysis of the appointment schedule associated with the service provider and the status indicator.

9. The one or more machine-readable media of claim 8, wherein the operations further comprise:
sending to one or more consumer computers an pre-intake questionnaire.

10. The one or more machine-readable media of claim 8, wherein the operations further comprise:
generating a graphical user interface that when rendered on a display device renders a visual representation of the virtual waiting room, the visual representation comprising a visual indicator of a number of patients in the virtual waiting room and a visual indicator of an amount of time a patient has been waiting in the virtual waiting room.

11. The one or more machine-readable media of claim 8, wherein the operations further comprise:
generating a graphical user interface that when rendered on a display device renders a visual representation of the virtual waiting room, the visual representation comprising a visual indicator of a number of patients in the virtual waiting room and a number of patients in the service provider's physical waiting room, and a visual indicator of an amount of time a patient has been waiting in the virtual waiting room.

12. The one or more machine-readable media of claim 8, wherein the operations further comprise:
generating a graphical user interface that when rendered on a display device renders a visual representation of a storefront that displays visual indicators of service providers associated with a medical practice.

13. The one or more machine-readable media of claim 8, wherein the operations further comprise:
determining that a requested service provider is not logged into the brokerage system;
identifying a service provider that is available to cover for the requested service provider; and
establishing a communication channel between the covering service provider and a consumer requesting a consultation.

14. The one or more machine-readable media of claim 8, wherein the operations further comprise:
determining by the one or more computer systems that the waiting room had reached a threshold capacity limit; and
closing by the one or more computer systems the waiting room to the admittance of new patients when the determined capacity has reached the threshold capacity.

15. An electronic system comprising:
one or more processing devices; and
one or more machine-readable media configured to store instructions that are executable by the one or more processing devices to perform operations comprising:
sending by one or more computers in response to a request a status indicator associated with a service provider that has a virtual waiting room generated by a computer system;
receiving by the one or more computers a request to enter the virtual waiting room;
accessing by the one or more computer systems an appointment schedule that indicates the service provider's appointments in a physically located office of the service provider;
analyzing by the one or more computers the request and the appointment schedule; and
causing the one or more computers to admit or deny entry to the virtual waiting room based at least in part on the analysis of the appointment schedule associated with the service provider and the status indicator.

16. The electronic system of claim 15, wherein the operations further comprise:
generating a graphical user interface that when rendered on a display device renders a visual representation of the virtual waiting room, the visual representation comprising a visual indicator of a number of patients in the virtual waiting room and a visual indicator of an amount of time a patient has been waiting in the virtual waiting room.

17. The electronic system of claim 15, wherein the operations further comprise:
generating a graphical user interface that when rendered on a display device renders a visual representation of a storefront that displays visual indicators of service providers associated with a medical practice.

18. The electronic system of claim 15, wherein the operations further comprise:
determining that a requested service provider is not logged into the brokerage system;
identifying a service provider that is available to cover for the requested service provider; and
establishing a communication channel between the covering service provider and a consumer requesting a consultation.

19. The electronic system of claim 15, wherein the operations further comprise:
determining by the one or more computer systems that the waiting room had reached a threshold capacity limit; and
closing by the one or more computer systems the waiting room to the admittance of new patients when the determined capacity has reached the threshold capacity.

20. The electronic system of claim 15, wherein the operations further comprise:
generating a graphical user interface that when rendered on a display device renders a visual representation of the virtual waiting room, the visual representation comprising a visual indicator of a number of patients in the virtual waiting room and a number of patients in the service provider's physical waiting room, and a visual indicator of an amount of time a patient has been waiting in the virtual waiting room.
